(19) United States
(12) Patent Application Publication
(10) Pub. No.: US 2011/0283615 A1
(43) Pub. Date: Nov. 24, 2011

(54) Seedling growing container

(76) Inventor: John Dickson, Rockville, MD (US)

(21) Appl. No.: 12/801,071

(22) Filed: May 20, 2010

(51) Int. Cl. A01G 9/02

(52) U.S. Cl. 47/66.6; 47/85

(57) ABSTRACT

A seedling growing container having a plurality of partitions removably mounted therein. The partitions are constructed and arranged to provide a plurality of trough-like configured cells containing seedlings and growing material. A humidity dome is also removably mounted on said container.

### BACKGROUND OF THE INVENTION

Various seedling growing containers have been proposed wherein a plurality of cells are supported by a flexible fluid-permeable fabric positioned in a tray. Seedlings and growing material are placed in the cells, and after the seedlings have matured, they are removed from the cells and transplanted to a plant pot or plant bed.

While these seedling growing containers have been satisfactory for their intended purpose, they have been characterized by certain disadvantages; namely, in some instances, when removing the matured seedlings and associated growing material from the cells, the growing material, at times, gets caught by the fluid-permeable fabrics thereby damaging the matured seedling. In other instances, the cells have to be destroyed when removing the matured plant seedling therefrom.

### SUMMARY OF THE INVENTION

In his continuing research and experimentation, applicant has devised the seedling growing container of the present invention wherein a container of the type disclosed in applicant's U.S. Pat. No. 7,658,034 dated Feb. 9, 2010, has a plurality of partitions removably mounted therein. Each partition comprises a pair of wall portions extending substantially 90 degrees from each other to form a corner. Each partition is positioned in the container so that its corner is positioned substantially in the center of the container with the wall portions extending radially outwardly therefrom to engage the inner surface of the plant container, to thereby form a plurality of circumferentially extending trough-like cells for receiving the seedlings and growing material.

A humidity dome is removably mounted on the container and comprises a transparent cup having ventilating holes in the side wall thereof. The cup is placed on the container in an upside down manner with the rim of the cup engaging a shoulder provided on the interior surface of the side wall of the container.

When it is decided to remove the seedling and associated growing material from the container, the container is tilted so that each trough carrying a matured seedling and associated growing material can be manually removed from the container.

### BRIEF DESCRIPTION OF THE DRAWINGS

FIG. 1 is a perspective view of the seedling growing container and humidity dome mounted thereon;

FIG. 2 is a perspective view of the seedling container shown in FIG. 1 with the humidity dome removed therefrom;

FIG. 3 is an exploded perspective view of the seedling growing container of the resent invention showing the container, the partitions and the humidity dome;

FIG. 4 is a perspective view of the container having the partitions positioned therein;

FIG. 5 is a top plan view of the container shown in FIG. 4;

FIG. 6 is a view taken along line 6-6 of FIG. 5; and,

FIG. 7 is a view taken along line 7-7 of FIG. 5.

### DESCRIPTION OF THE PREFERRED EMBODIMENT

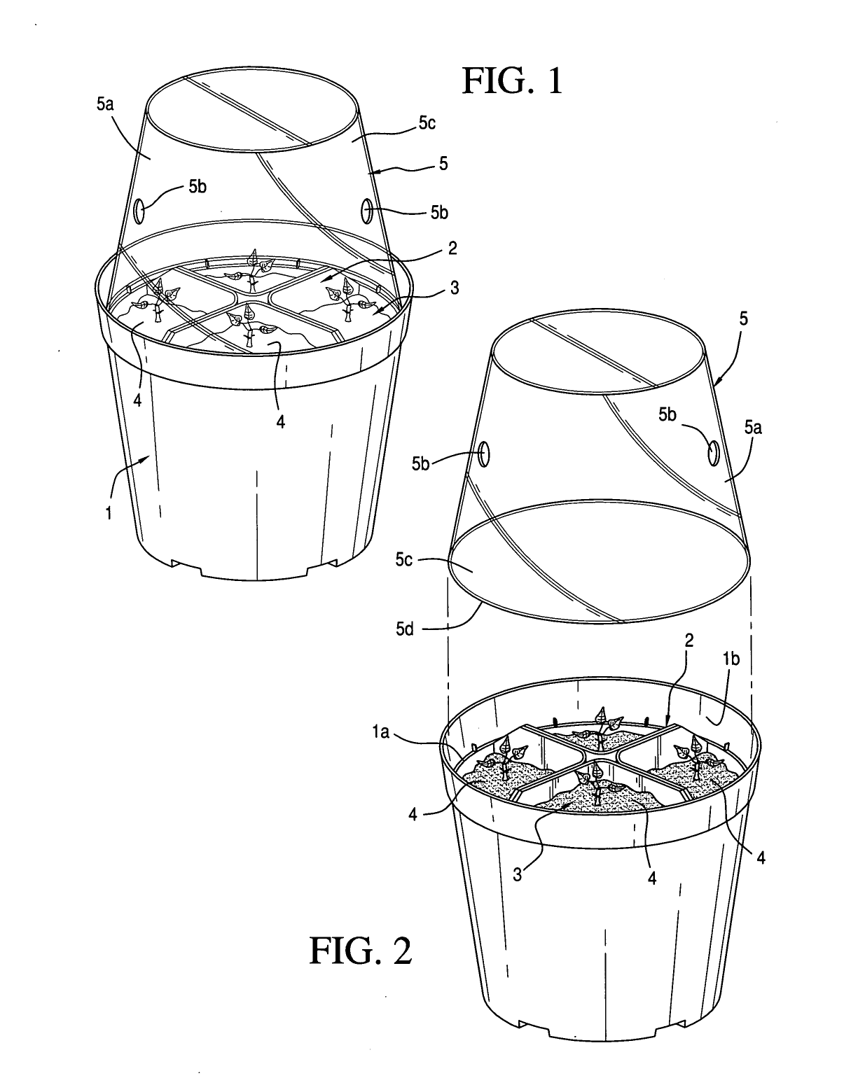

Referring to the drawings and more particularly to FIGS. 1 and 2, the seedling growing container of the present invention comprises a container 1 having a plurality of partitions 2 removably mounted therein forming a plurality of cells 3 for receiving seedlings and growing material 4. A humidity dome 5 is removably mounted on the container 1 and comprises a transparent cup 5a having ventilating holes 5b in the side wall 5c thereof. The cup 5a is placed on the container 1 in an upside down manner with the rim 5d of the cup 5a engaging a shoulder 1a provided on the interior surface of the side wall 1b of the container.

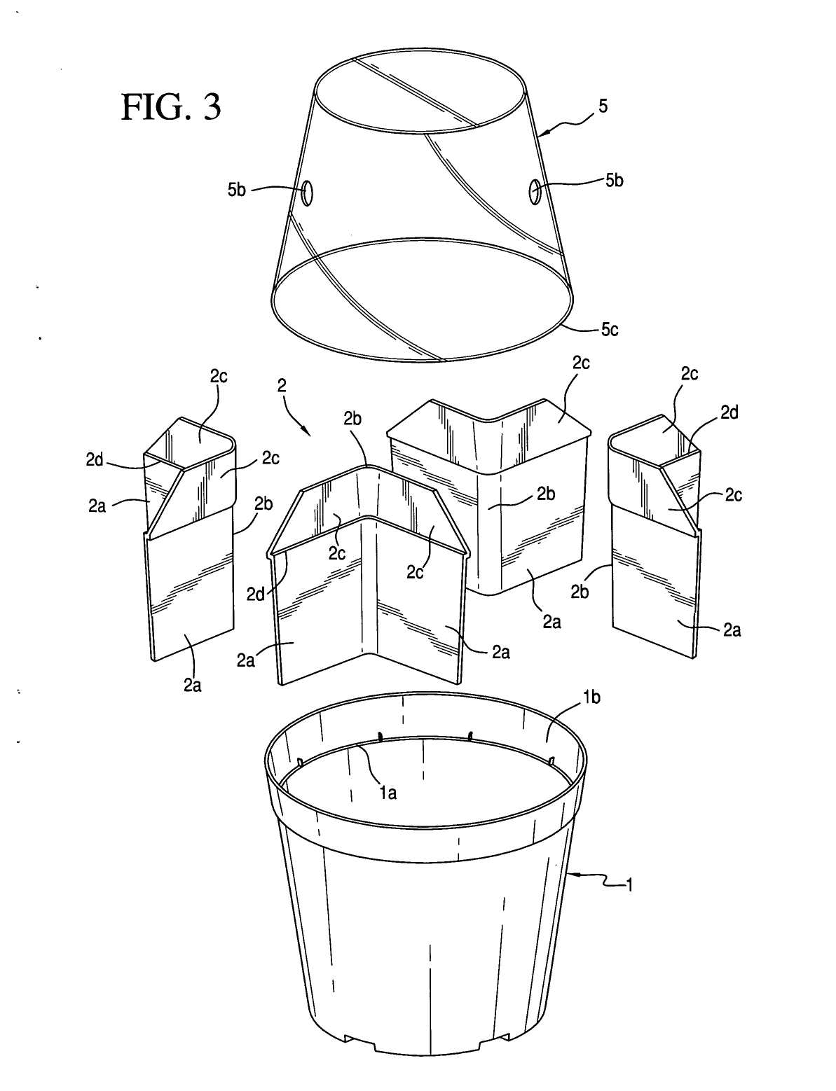

The details of the construction of the partitions 2 are illustrated in FIG. 3 wherein it will be seen that each partition comprises a pair of wall portions 2a extending substantially 90 degrees from each other to form a corner 2b. The upper wall portion 2c of each partition is offset from its respective lower wall portion 2a to thereby form a shoulder 2d whereby the partitions 2 are reinforced from bending outwardly when the container 2 is filled with the seedlings and growing material.

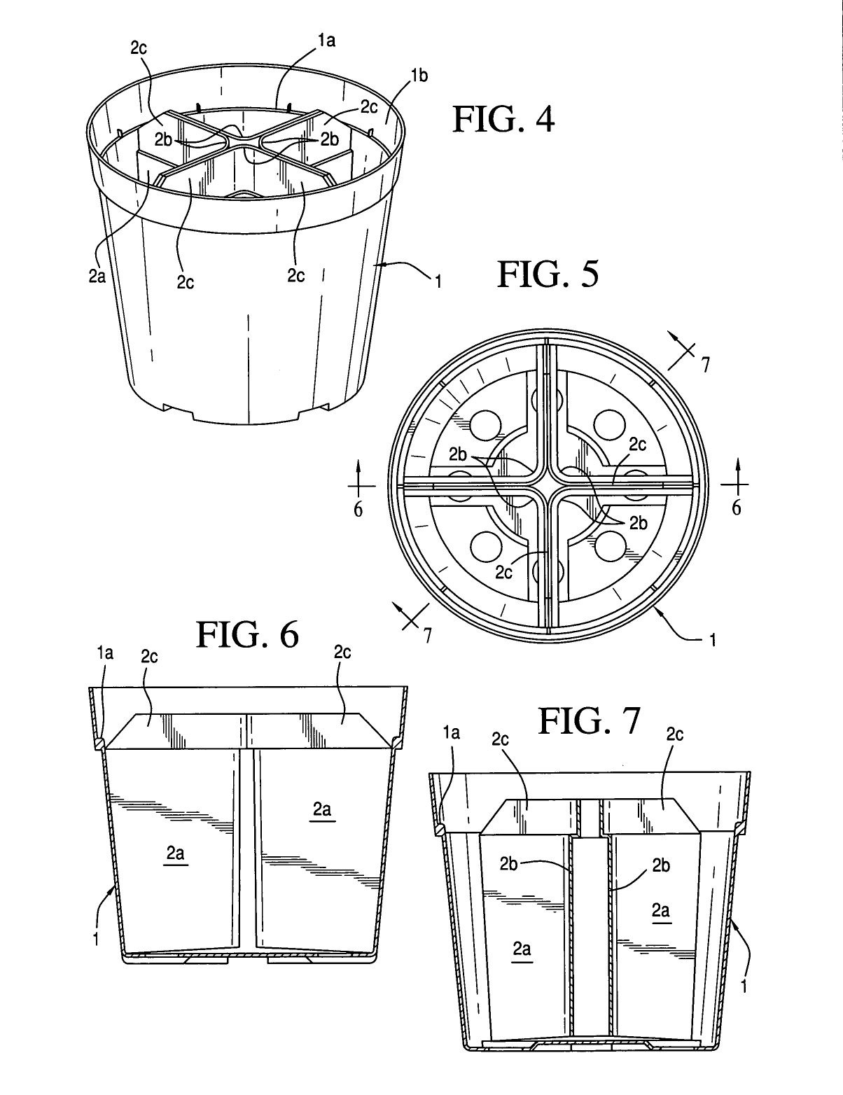

As will be seen in FIGS. 4 to 7, each partition 2 is positioned in the container 1 so that its corner 2b is positioned substantially in the center of the container 1 with the wall portions 2a, 2c extending radially outwardly therefrom to engage the inner surface 1c of the plant container 1, to thereby provide the plurality of cells 3 for receiving the seedlings and growing material 4.

The construction and arrangement of the wall portions 2a, 2c are such that each partition 2 forms a trough containing a portion of the seedlings and growing material 4. When removing the seedlings and growing material 4 from the container 1, the container 1 is tilted and each partition 2 carrying a portion of the seedlings and growing material 4 in its trough is manually removed from the container 1.

From the above description it will be appreciated by those skilled in the art that the seedling growing container is an improvement over prior seedling growing containers in that the seedlings and growing material 4 can be easily removed from each cell without damaging the seedling nor destroying the cell.

It is to be understood that the form of the invention herewith shown and described is to be taken as a preferred example of the same, and that various changes in the shape, size and arrangement of parts may be resorted to without departing from the spirit of the invention or scope of the subjoined claims.

I claim:

1. A seedling growing container comprising a container, a plurality of partitions removably mounted in said container, each partition having a pair of wall portions extending substantially 90 degrees from each other to form a corner, each portion being placed in said container so as to position its corner substantially in the center of the container with the wall portions extending radially outwardly therefrom to engage the inner surface of the container, to thereby form a plurality of circumferentially extending trough-like cells and seedlings and growing material contained within said cells.

2. A seedling growing container according to claim 1, wherein a humidity dome is removably mounted on the container.

3. A seedling growing container according to claim 2, wherein the humidity dome comprises a transparent cup having a rim and ventilating holes in the side wall of said cup, said cup being placed on said container in an upside down manner, the rim of said cup engaging a shoulder on the interior surface of the side wall of the container.

4. A seedling growing container according to claim 1, wherein each partition is provided with a reinforcing shoulder to prevent the wall portions from bending when the cell is filled with seedlings and growing material.
